(19) United States
(12) Patent Application Publication
(10) Pub. No.: US 2017/0106315 A1
(43) Pub. Date: Apr. 20, 2017

(54) Steamin Deamon

(71) Applicant: Robert Rae Norwood, Rockwall, TX (US)

(72) Inventor: Robert Rae Norwood, Rockwall, TX (US)

(21) Appl. No.: 14/883,308

(22) Filed: Oct. 14, 2015

(51) Int. Cl. B01D 35/18; B04C 9/00; B01D 35/00; B01D 1/00

(52) U.S. Cl. CPC B01D 35/185; B01D 1/0011; B01D 35/18; B04C 9/00; B01D 35/005; B04C 2009/002

(57) ABSTRACT

The nature of the technical disclosure contained in the attached utility patent application is the methodology by which liquid and particulate contaminants are removed from used, dirty engine and machinery oil. The methodology includes the use of heat, vacuum and high pressure filtering.

### CROSS-REFERENCE TO RELATED APPLICATIONS

None

### FEDERALLY SPONSORED RESEARCH AND DEVELOPMENT

There has been no federally sponsored research and development related to this invention.

### PARTIES TO A JOINT RESEARCH AGREEMENT

There are no parties related to a joint research agreement.

### SEQUENCE LISTING

There are no sequence listings relating to this invention.

### PRIOR DISCLOSURES

There are no prior disclosures related to this invention.

### BACKGROUND OF THE INVENTION

The seed for the development of the invention was planted more than seven years ago by the applicant, Robert R. Norwood. Mr. Norwood, at the time, was consulting with a top fuel drag race team and determined that the team would be better served by recycling the engine oil from their race cars rather than replacing the oil in the engine following each pass down the drag strip

### SUMMARY OF THE INVENTION

The invention is a device, contained within a cabinet-sized unit that recycles oil drained from engines and machinery of all types. The used, dirty oil from the engine or machinery is cleaned and filtered down to a particle size of one micron by the unit. The cleaned oil can be re-used in the very engine or machinery out of which it was drained, allowing the oil to be employed over and over for the life of the engine or machinery. A formerly discarded material is now recycled, promoting sustainability by eliminating an end-of-life event for millions of gallons of engine oil annually. The Steamin Deamon is assembled from a series of tanks, valves, hoses, centrifugal separators, pumps (both vacuum and pressure), relays and heaters, all of which are controlled by custom designed surface mount PCB connected to a touch screen control panel.

### BRIEF DESCRIPTION OF THE SEVERAL VIEWS OF THE DRAWINGS

FIG. 1. The first drawing, labeled Drawing #1, Figure A, is a plan view of the components of a single tank Steamin Deamon unit with each component labeled for identification. The numbers in the labels indicate the order in which the used oil enters the unit, is processed and exits the unit.

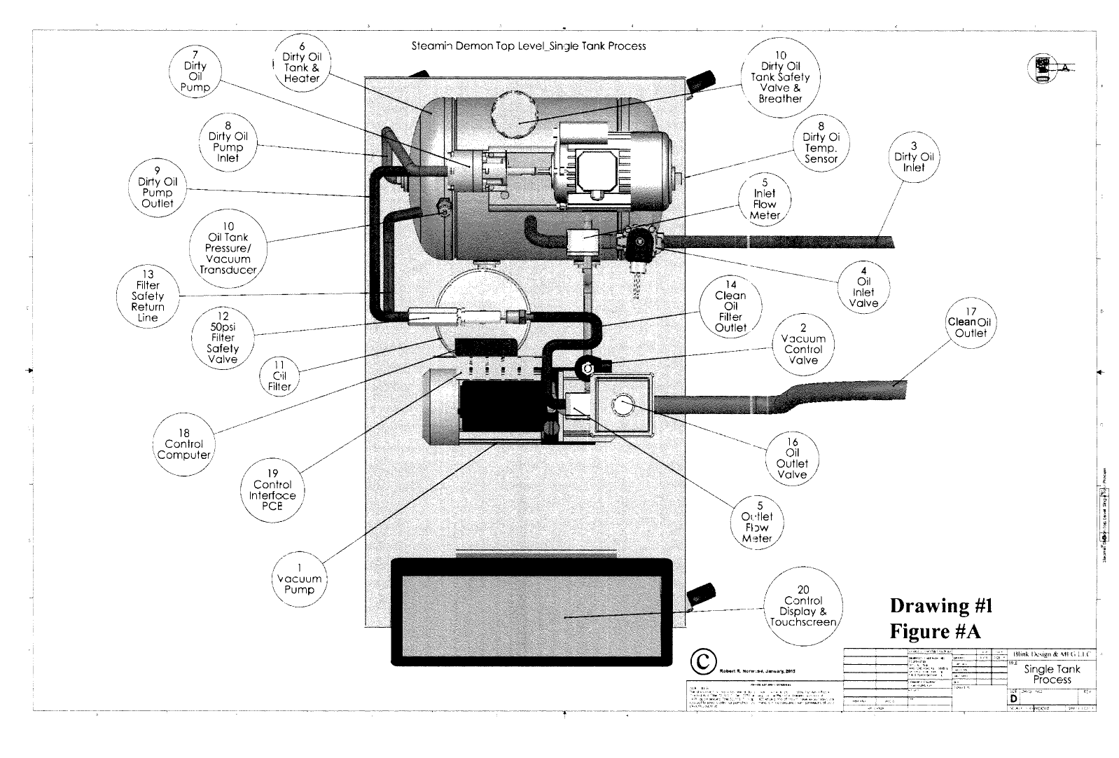

FIG. 2. The second drawing, labeled Drawing #2, Figure A, is a plan view of the components of a two tank Steamin Deamon unit with each component labeled for identification. The numbers in the labels indicate the order in which the used oil enters the unit, is processed and exits the unit.

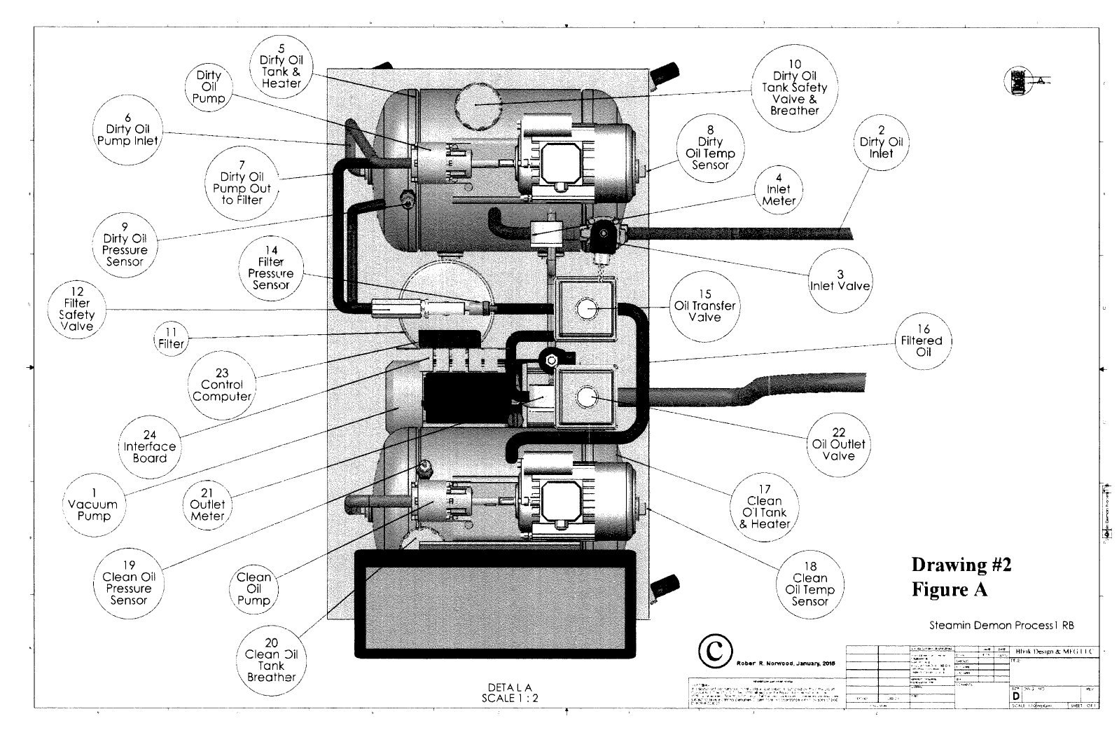

FIG. 3. The third drawing, labeled Drawing #3, Figure A, is a three dimensional view of the same single tank Steamin Deamon unit that is shown in Drawing #1, Figure A.

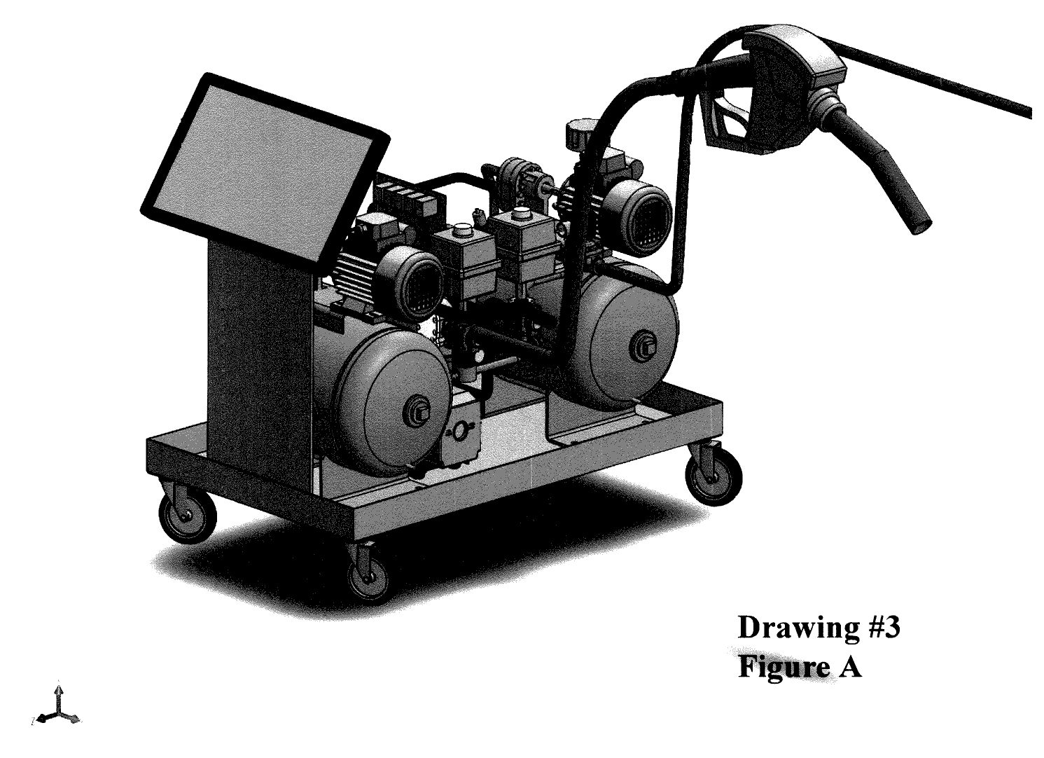

FIG. 4. The fourth drawing, labeled Drawing #4, contains a series of drawings. Figure A is an oblique, 3D view of the two tank unit shown in Drawing #2, Figure A. Figure B is a plan view of the same two tank unit. Figure C is a rear elevation view of the same two tank unit. Figure D is a side elevation view of the two tank unit. Figure E is a front elevation view of the two tank unit. Each view is provided with labels identifying the components along with a legend box that lists the components.

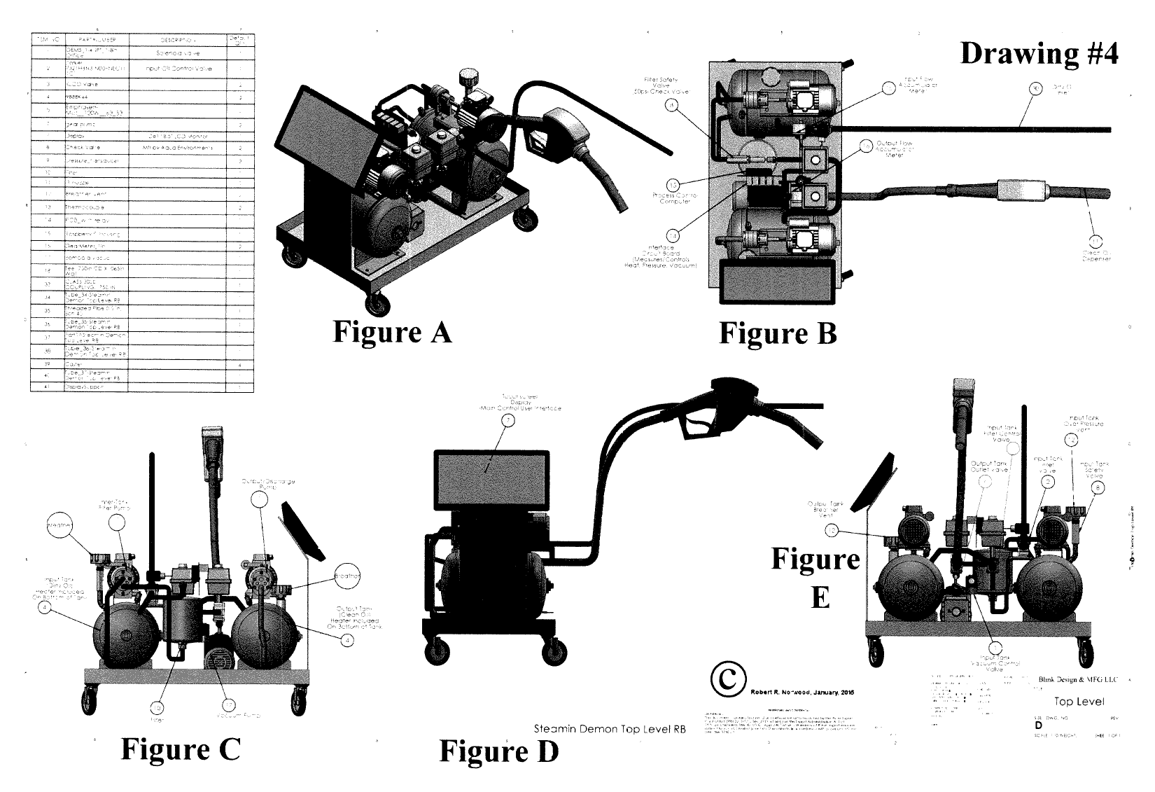

### DESCRIPTION OF THE ASSEMBLY

The assembly of the Steamin Deamon can be seen in the drawings included with this specification description. Please refer to the drawing entitled “Steamin Deamon Top Level_Single Tank Process” for the following assembly description.

The assembly begins with a cart that is approximately eighteen inches by thirty six inches in size, which is mounted on four casters. The primary tank (#6 in drawing), which holds five gallons of used, dirty oil is mounted on the cart at the rear. (NOTE: The size and number of primary tanks can be varied to accommodate different sized engines and different uses of the unit. See “Steamin Deamon Process 1 RB” drawing for multi tank illustration.) The primary tank includes a heater for the oil. A vacuum pump (#1 in drawing) is mounted in front of the primary tank. A high pressure oil filter (#11 in drawing) is mounted between the primary tank and the vacuum pump. The vacuum control valve (#2 in drawing) and the dirty oil inlet hose (#3 in drawing) and flow meter (#5 in drawing) are connected to the primary tank. The dirty oil pump (#7 in drawing) and the oil tank pressure/vacuum transducer (#10 in drawing) are mounted to the primary tank. The dirty oil inlet hose (#8 in drawing), the dirty oil outlet hose (#9 in drawing) and the oil filter safety return hose (#13 in drawing) are connected to the primary tank. The filter safety valve (#12 in the drawing) is installed to the oil filter. The clean oil filter outlet line (#14 in the drawing) is installed from the filter to the outlet flow meter (#15 in the drawing), which is attached to the oil outlet valve (#16 in the drawing). The clean oil outlet #17 in the drawing) is then attached.

Final assembly includes the installation of the wiring harness for the Steamin Deamon, which attaches to the control computer (#18 in the drawing) and control interface PCB (#19 in the drawing) as well as the control display and touchscreen (#20 in the drawing).

The drawing views include a two tank version of the invention along with a single tank version of the invention. Another drawing depicts the 3D view of the single tank version of the invention. The multiple view drawing includes elevation and plan drawings of the two tank version of the invention.

### DETAILED DESCRIPTION OF THE INVENTION

Power is applied to the wiring harness of the Steamin Deamon (configuration for various voltages, both AC and DC are possible. Standard unit is configured for 110v AC). With power applied, the heaters, motors and pumps become operable subject to the direction of the computer controls. The unit is connected to a used, dirty oil source, usually either the sump of an engine or by connection to a drum of dirty oil. The used, dirty oil is pumped into the primary tank after passing through a coarse filtering membrane. Once the primary tank is full, the user engages the unit, by way of the touch screen, to initiate the recycling process. The heater and vacuum pump begin their cycle to heat the oil, create a vacuum environment and remove water, alcohol and other liquid contaminants from the used, dirty oil. Once the first cycle is complete, usually in about fifteen minutes, the computer directs the still heated oil to a centrifugal separator, then through a series of filtering membranes under pressure. At this point, in a multi-tank configuration, the clean oil is pumped into the second tank for use in the future. The unit may be configured with a heater in the second tank in order to heat the clean oil in the second tank. In the single tank configuration, the clean oil is pumped directly into a waiting vessel, either the original engine or a storage tank or a barrel or a can.

1. No invention or process on record combines heat and vacuum to remove water, alcohol and other moisture from used oil.

2. No invention or process on record combines heat and pressure to filter oil to the level of one micron creating usable recycled oil while retaining additive packages in the oil.

3. No invention or process on record removes particulates that are less than one micron through the use of a centrifugal clarifier.
